(19) United States
(12) Patent Application Publication
(10) Pub. No.: US 2005/0078759 A1
(43) Pub. Date: Apr. 14, 2005

(54) Subcarrier and bit allocation for real time services in multiuser orthogonal frequency division multiplex (OFDM) systems

(75) Inventor: Guodong Zhang, Farmingdale, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/926,829

(22) Filed: Aug. 26, 2004

Related U.S. Application Data
(60) Provisional application No. 60/498,074, filed on Aug. 27, 2003.

(51) Int. Cl. H04K 1/10

(52) U.S. Cl. 375/260

(57) ABSTRACT

The method of the present invention provides efficient resource allocation in terms of subcarrier, bit and corresponding power of QoS for real time services in multiuser OFDM systems. The invention takes advantage of the instantaneous channel gain in subcarrier and bit allocation using an iterative approach.

### CROSS REFERENCE TO RELATED APPLICATION

This application claims priority from U.S. provisional application No. 60/498,074 filed on Aug. 27, 2003, which is incorporated by reference as if fully set forth.

### FIELD OF INVENTION

The present invention relates to wireless communications systems using orthogonal frequency division multiplex, wherein an optimal solution is desired for subcarrier and bit allocation.

### BACKGROUND

Wireless communication networks are increasingly being relied upon to provide broadband services to consumers, such as wireless Internet access and real-time video. Such broadband services require reliable and high data rate communications under adverse conditions such as hostile mobile environments, limited available spectrum, and intersymbol interference (ISI) caused by multipath fading.

Orthogonal frequency division multiplex (OFDM) is one of the most promising solutions to address the ISI problem. OFDM has been chosen as a preferred technique for European digital audio and video broadcasting, and wireless local area network (WLAN) standards.

For single user OFDM systems, an approach known as the “water-filling” approach can be used to find the subcarrier and bit allocation solution that minimizes the total transmit power. The water filling algorithm optimizes allocations based on the requirements of a single user, without taking into consideration the effects of the single user on resource allocation for all users. Therefore in multiuser OFDM systems, the subcarrier and bit allocation which is best for one user may cause undue interference to other users.

In multiuser OFDM systems, the subcarrier and bit allocation is much more complex than in single user OFDM systems, in part because the best subcarrier (in terms of channel gain) of one user could be also the best subcarrier of other users. Several users should not use the same subcarrier at the same time because the mutual interference between users on the same subcarrier will decrease the throughput. This makes the subcarrier and bit allocation in multiuser OFDM systems much more complicated than single user OFDM systems. Thus, used alone, the water-filing approach is inadequate for multiuser OFDM systems.

There has been some recent research on algorithms for subcarrier and bit allocation in multiuser OFDM systems. Those algorithms can be categorized into two general types: 1) static subcarrier allocation; and 2) dynamic subcarrier allocation. Two typical static subcarrier allocation algorithms are OFDM time division multiple access (OFDM-TDMA) and OFDM frequency division multiple access (OFDM-FDMA). In OFDM-TDMA, each user is assigned one or more predetermined timeslots and can use all subcarriers in the assigned time slot(s). In OFDM-FDMA, each user is assigned one or several predetermined subcarriers. In these static schemes, subcarrier allocations are predetermined and do not take advantage of the knowledge of instantaneous channel gain.

Dynamic subcarrier allocation schemes consider instantaneous channel gain in subcarrier and bit allocation. Most of those schemes result in very complex solutions. A typical subcarrier and bit allocation algorithm models the subcarrier and bit allocation problem as a nonlinear optimization problem with integer variables. Solving the nonlinear optimization problem is extremely difficult and does not yield an optimal solution.

### SUMMARY

The present invention is a method for resource allocation in terms of subcarrier, bits and corresponding power given the quality of service (QoS) for real time services in multiuser OFDM systems. The goal of a subcarrier and bit allocation scheme for real time services in multiuser OFDM systems is to find the best allocation solution that requires the lowest total transmit power given the required QoS and bits to transmit. The present invention presents a dynamic subcarrier and bit allocation scheme for multiuser OFDM systems. The method takes advantage of the instantaneous channel gain in subcarrier and bit allocation by using an iterative approach. A single user water-filling algorithm is used to find the desired subcarriers of each user independently, but only as a partial step. In the case of multiuser OFDM, the present invention uses a method that determines the most appropriate subcarrier for each user. If no more than one user is competing for a subcarrier, then reassignment of a subcarrier to resolve the conflicting subcarriers will not have to be performed. If more than one user is competing for a subcarrier, the present invention iteratively searches for the subcarrier-to-user reassignment that resolves the conflicting subcarriers and yields the least required transmit power to meet the required QoS.

### BRIEF DESCRIPTION OF THE DRAWINGS

A more complete understanding of the invention may be had from the following description of a preferred embodiment, given by way of example, and to be understood in conjunction with the accompanying drawings herein:

FIG. 1 is a block diagram of a multiuser OFDM system with subcarrier and bit allocation.

FIG. 2 is a flow diagram of a subcarrier and bit allocation method for a single user OFDM system according to one aspect of the present invention.

FIG. 3 is a flow diagram of a subcarrier and bit allocation method for a multiuser OFDM system according to another aspect of the present invention.

### DETAILED DESCRIPTION OF THE PREFERRED EMBODIMENTS

Although the features and elements of the present invention are described in the preferred embodiments in particular combinations, each feature or element can be used alone (without the other features and elements of the preferred embodiments) or in various combinations with or without other features and elements of the present invention.

As used hereinafter, the terminology “wireless transmit/receive unit” (WTRU) includes but is not limited to a user equipment (UE), mobile station, fixed or mobile subscriber unit, pager, or any other type of device capable of operating in a wireless environment. These exemplary types of wireless environments include, but are not limited to, wireless local area networks (WLANs) and public land mobile networks. The terminology “base station” includes but is not limited to a Node B, site controller, access point or other interfacing device in a wireless environment.

The system and method of the present invention present a subcarrier and bit allocation scheme, which take advantage of the knowledge of instantaneous channel gain in subcarrier and bit allocation. In the case that a subcarrier is desired by more than one user, the subcarrier is assigned to one of the users as appropriate so that total transmit power is minimized.

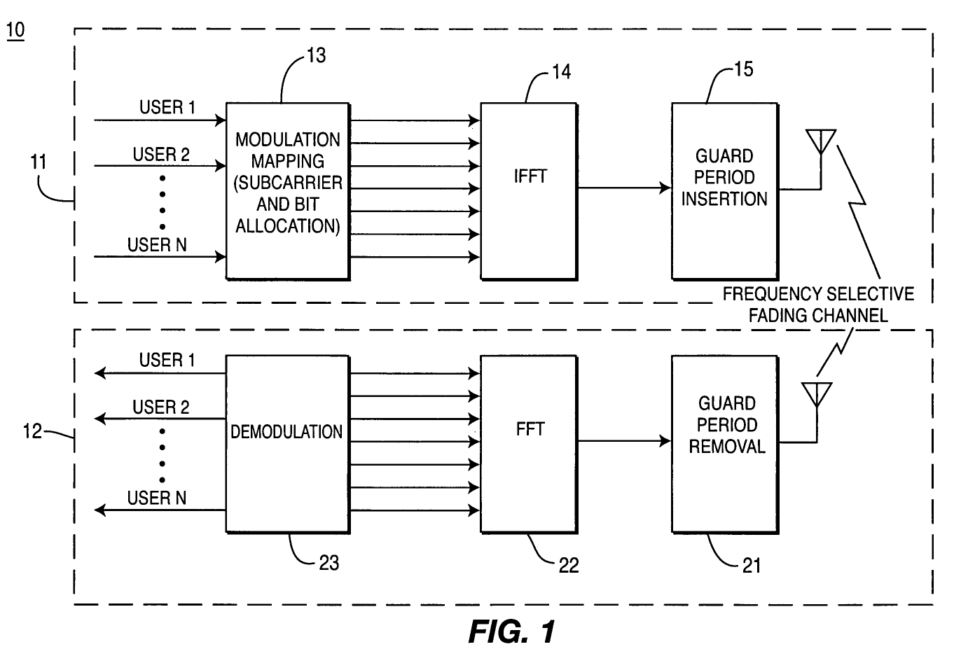

Referring to FIG. 1, a block diagram of a multiuser OFDM system 10 with subcarrier and bit allocation made in accordance with the present invention is shown. The system 10 generally includes a transmit module 11, (most likely to be incorporated in a base station, however it can be within a WTRU as well), and a receive module 12, (most likely to be incorporated in a WTRU, however it can be within a base station as well). Depicted in the transmit module 11 are a modulation mapping (MM) module 13, an inverse fast Fourier transform (IFFT) module 14, and a guard period insertion module 15. The MM module 13, IFFT module 14 and guard period insertion module 15 facilitate transmission of the signal.

The MM module 13 determines the assignment of subcarriers to users, and the number of bits to be transmitted on each subcarrier. Based on the number of bits to be transmitted on a subcarrier, the MM module 13 further applies the corresponding modulation schemes and determines the appropriate transmit power level in the subcarrier as well.

The IFFT module 14 transforms the output complex symbols of the MM module 13 into time domain samples by using IFFT. The guard period insertion module 15 inserts a guard period to the end of each OFDM time domain symbol in order to alleviate the inter-symbol interference prior to transmission via a first RF module and antenna 16.

In the receive module 12 are a second RF module and antenna 17, a guard period removal module 21, a fast Fourier transform (FFT) module 22 and a demodulator 23. The guard period removal module 21 removes the guard period. Then, the FFT module 22 transforms the time domain samples into modulated symbols. Finally, the demodulation module 23 applies corresponding demodulation schemes to restore the user data. While there is a general correspondence between the transmit module 11 and the receive module 12, the functions are necessarily different.

The present invention assumes that there are N real-time users and K subcarriers in the multiuser OFDM system. For each user n, there are Rₙ bits of data to transmit. The invention also assumes that the bandwidth of each subcarrier is sufficiently smaller than the coherence bandwidth of the channel. The information of instantaneous channel gain of all users on each subcarrier is available to the transmitter, and therefore the transmitter can utilize the information to determine the assignment of subcarriers to users and the number of bits that can be transmitted on each subcarrier.

Generally, a plurality of modulation schemes, (such as BPSK, QPSK, QAM and etc.), can be used in the OFDM systems. For the purpose of illustration, it is assumed that an M-ary quadrature amplitude modulation (QAM) is used in the system. Let fₙ(r) denote the required received power when r bits of user n are transmitted on a subcarrier. Given that the required bit error rate (BER) of the user n is BERN, and N₀ is the noise power, the required power to transmit r bits per symbol is given by:

$${f}_{n} ( r ) = \frac{{N}_{0}}{3} \cdot {[ {Q}^{- 1} ( \frac{{BER}_{n}}{4} ) ]}^{2} \cdot ( {2}^{r} - 1 ) \qquad Equation ( 1 )$$

Let rₖ(n) denote the number of bits of nth user assigned to the kth subcarrier, and the gain of the channel between the user n and the base station (BS) on the kth subcarrier is G_{k,n}. In order to maintain the required quality of service (QoS), the allocated transmit power which is allocated to user n on the kth subcarrier, Pₖ(n), is given by:

$${P}_{k} ( n ) = \frac{{f}_{n} ( {r}_{k} ( n ) )}{{G}_{k , n}^{2}} \qquad Equation ( 2 )$$

The total transmit power (Pₜₒₜₐₗ) of all users on all subcarriers is given by:

$${P}_{total} = {\sum }_{k = 1}^{K} {\sum }_{n = 1}^{N} {P}_{k} ( n ) = {\sum }_{k = 1}^{K} {\sum }_{n = 1}^{N} \frac{{f}_{n} ( {r}_{k} ( n ) )}{{G}_{k , n}^{2}} \qquad Equation ( 3 )$$

Since the services being considered are real-time services, the number of bits needed to be transmitted per symbol is fixed (i.e. the data is not buffered for transmission later on). This means that:

$${\sum }_{k = 1}^{K} {r}_{k} ( n ) = {R}_{n} \qquad Equation ( 4 )$$

The goal of the subcarrier and bit allocation algorithm for real-time services in multiuser OFDM systems is to find the best allocation solution that requires the lowest total transmit power given the required QoS and bits to transmit.

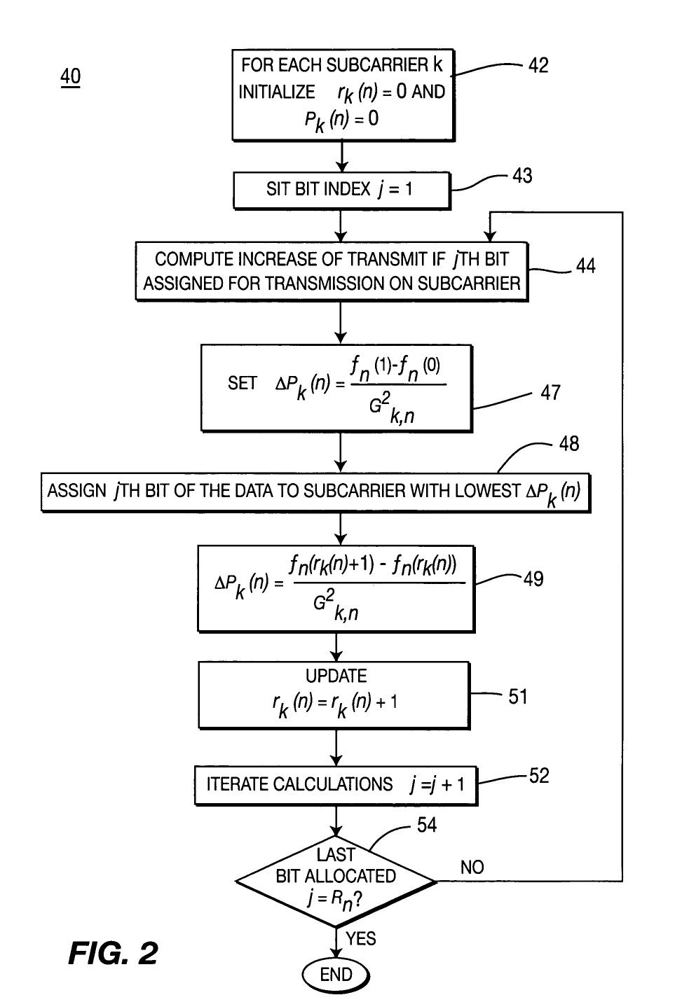

The present invention is a system and method for subcarrier and bit allocation that is applicable for multiuser OFDM communication systems. The subcarrier and bit allocation method 40 for a single user n, (as if all the subcarriers can be used by this user), follows multiple steps as depicted in the flow diagram of FIG. 2. Essentially, the single user water-filling algorithm of FIG. 2 is used to determine the acceptance or denial of subcarriers for each user independently. First, for each subcarrier k, the algorithm is initialized, with the number of bits for user n on the subcarrier and the transmit power of user n on the subcarrier as zero. That is, rₖ(n)=0 and Pₖ(n)=0 (step 42).

The method 40 starts with the first bit of the data, bit index j=1 (step 43). For each subcarrier k, the increase of transmit power if the jth bit is assigned to be transmitted on this subcarrier is computed (step 44). A determination of a change in allocated transmit power Pₖ on the kth subcarrier (step 45) is then calculated (step 47):

$$Δ {P}_{k} ( n ) = \frac{{f}_{n} ( {r}_{k} ( n ) + 1 ) - {f}_{n} ( {r}_{k} ( n ) )}{{G}_{k , n}^{2}} ; \qquad Equation ( 5 )$$

so that:

$$Δ {P}_{k} ( n ) = \frac{{f}_{n} ( 1 ) - {f}_{n} ( 0 )}{{G}_{k , n}^{2}} . \qquad Equation ( 6 )$$

The jth bit of the data is then assigned to the subcarrier that has the lowest ΔPₖ(n) (step 48).

The increase of transmit power of user n on subcarrier k is updated (step 49):

$$Δ {P}_{k} ( n ) = \frac{{f}_{n} ( {r}_{k} ( n ) + 1 ) - {f}_{n} ( {r}_{k} ( n ) )}{{G}_{k , n}^{2}} \qquad Equation ( 7 )$$

The number of bits of user n on subcarrier k is then updated (step 51):
rₖ(n)=rₖ(n)+1; Equation (8)
and the data bit index is then incremented (step 52):
j=j+1. Equation (9)

It is then determined whether the last bit of data has been allocated (step 54); in essence, whether j=Rₙ. In the case of a single user, step 54 would be the last step of the algorithm. However, in order to allocate all bits, steps 44-54 are repeated in order to obtain an optimal allocation solution for the user with the minimum transmit power based on the power calculations.

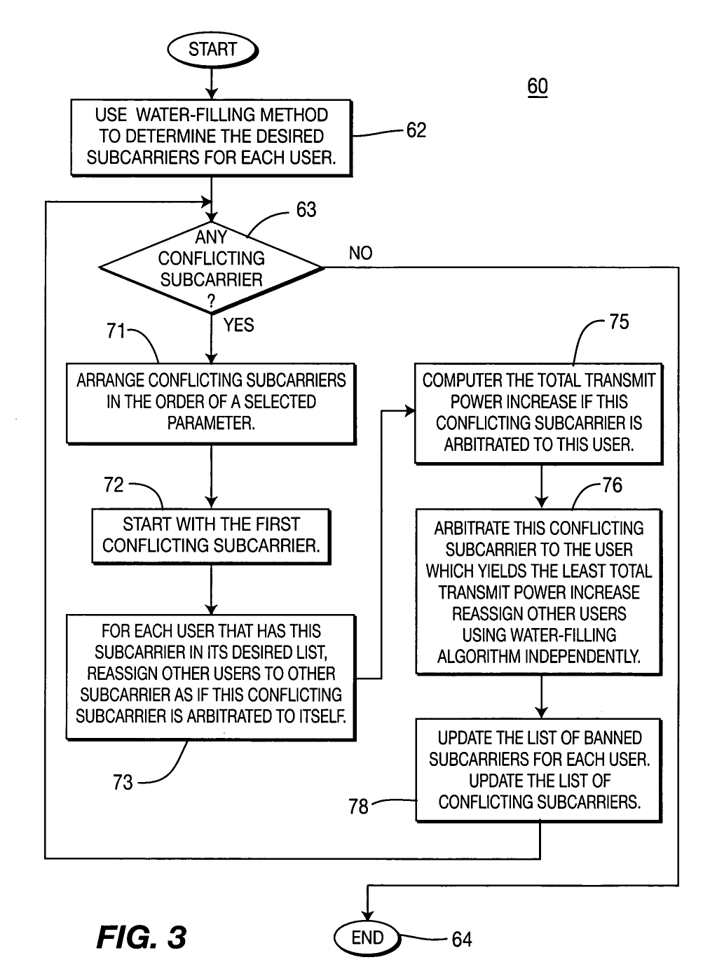

Referring to FIG. 3, a resource allocation method 60 in the case of multiuser OFDM systems in accordance with the present invention is shown. As aforementioned, the single user water-filling method 40 of FIG. 2 is used to determine the desired subcarriers for each user independently (step 62). This step allocates subcarriers and bits as if all subcarriers can be used exclusively by the same user. In this way, the desired list of subcarriers, and number of bits allocated on each subcarrier, are obtained for each user. The transmit power of each user on each subcarrier is computed as if the subcarrier is used only by this user.

A determination is made as to whether any conflicting subcarriers exist (step 63). If no conflicting subcarriers exist, the method 60 terminates (step 64) since the optimal allocation solution for the multiuser OFDM system has been found. However, if a subcarrier is in the list of desired subcarriers of several users, this subcarrier is called a conflicting subcarrier, because a subcarrier can only be assigned to one user at a given point in time.

If subcarriers are found to conflict in step 63, the conflicting subcarriers are arranged (step 71). If a conflicting subcarrier k is in the desired list of M users (n₁, n₂, . . . , n_{M}), the total transmit power (Pₖ) on subcarrier k is defined as the sum of each conflicting user's transmit power on this subcarrier:

$${P}_{k} = {\sum }_{j = 1}^{M} {P}_{k} ( {n}_{j} ) . \qquad Equation ( 10 )$$

In the exemplary embodiment, conflicting subcarriers are arranged in the order of decreasing total transmit powers of the subcarrier. Other options for ordering conflicting subcarriers into sequence include:
a. Arrange in the order of decreasing statistics of channel gain of the subcarrier. The statistics of channel gain of a conflicting subcarrier can be one of the following metrics:
i. The total sum of channel gain of users n₁, n₂, . . . , n_{M} on this conflicting subcarrier:

$${G}_{k\_total} = {\sum }_{j = 1}^{M} {G}_{k , {n}_{j}} . \qquad Equation ( 11 )$$
ii. The average of channel gain of users n₁, n₂, . . . , n_{M} on this conflicting subcarrier:

$$\overline{{G}_{k}} = \frac{1}{M} {\sum }_{j = 1}^{M} {G}_{k , {n}_{j}} . \qquad Equation ( 12 )$$
iii. The best channel gain of users n₁, n₂, . . . , n_{M} on this conflicting subcarrier:
   Gₖ_{_{—}}_{best}=max{G_{k,n}_{₁},G_{k,n}_{₂}, . . . ,G_{k,n}_{_{M}}}. Equation (13)
b. Arrange in the order of decreasing total number of bits of the subcarrier.

$${r}_{total} = {\sum }_{j = 1}^{M} {r}_{k} ( {n}_{j} ) . \qquad Equation ( 14 )$$

The conflicting subcarriers are therefore arranged according to a predetermined parameter such as total transmit power, statistics of channel gain, total number of bits, or noise; although other parameters may be utilized.

After rearranging the conflicting subcarriers (step 71) into a sequence according to a specific order, the first conflicting subcarrier is selected (step 72). Obviously, this subcarrier will be arbitrated to one user (for example, user nⱼ). A list of banned subcarriers is maintained for each user throughout the subcarrier and bit allocation process. The banned list of a user includes conflicting subcarriers that are not arbitrated to this user in previous steps. For each user nⱼ that has this subcarrier in its desired list, bits currently allocated to this conflicting subcarrier are reassigned to other subcarriers using the single user water-filling algorithm in method 40 in FIG. 2 as if the conflicting subcarrier is arbitrated to the user nⱼ (step 73).

The reassignment in step 73 results in the solution vector {rₖ(nₕ)}ₖ₌₁^{K}, which is the obtained optimal reallocation solution for all other users under the condition that subcarrier I is arbitrated to user nⱼ. In step 75, the algorithm computes the required transmit power of reassigned bits and denote it by P_{reassign}(rₕ(nₕ)), which is larger than the transmit power of bits of user nₕ currently allocated on the conflicting subcarrier l. The transmit power of bits of user nₕ currently allocated on the conflicting subcarrier l is Pₗ(nₕ). Then, the increase of transmit power caused by the reassignment of bits of the user nₕ, denoted by ΔPₙ_{ₕ}, is given by:
ΔPₙ_{ₕ}=P_{reassign}(rₕ(nₕ))−Pₗ(nₕ) Equation (15)
The total power increase determined when the conflicting subcarrier is arbitrated to user nⱼ is given by:

$$Δ {P}_{total} ( {n}_{j} ) = {\sum }_{h = 1 , h \neq j}^{M} Δ {P}_{{n}_{h}} \qquad Equation ( 16 )$$

This value is considered to be the total transmit power increase which is based on the conflicting subcarrier being arbitrated to the user nⱼ (step 75). After steps 73 and 75 are repeated for each user having the conflicting subcarrier in its desired list, the transmit power increases calculated in step 75 are compared. The conflicting subcarrier is then arbitrated to the user which results in the least total transmit power increase.

It should be noted that as subcarriers are reallocated in step 76, and the method 40 of FIG. 2 is used to reallocate the remaining conflicting subcarriers (step 76), new conflicting subcarriers may be generated. The new conflicting subcarriers, if any, are added to the list of conflicting subcarriers according to the order of the selected parameter, such as decreasing total transmit power on the conflicting subcarrier in step 78. The list of banned subcarriers is for each user is then updated (step 78). The method 60 then returns to step 63 to resolve other conflicting subcarriers, if any. The iteration is continued until the list of conflicting subcarriers becomes empty.

The method 60 can be initiated upon sensing a significant change in status of users, a change in signal status, a change in channel condition at a predetermined time interval (for example every frame or every a few frames) or by some other convenient reference.

1. A method for assigning subcarriers in a multiuser orthogonal frequency division multiplex (OFDM) carrier assignment, the method comprising:
(a) determining a list of desired subcarriers for each user;
(b) identifying conflicting subcarriers, and if no conflicting subcarriers exist, skipping to step (f);
(c) listing the conflicting subcarriers based upon a specific criteria in a predetermined order and selecting the first conflicting subcarrier;
(d) arbitrating the conflicting subcarrier to the user that results in the least total transmit power increase;
(e) reassigning other users that have conflicting subcarriers in their desired list to other subcarriers and returning to step (b); and
(f) accepting the determination of the desired subcarriers for each user.

2. The method of claim 1, wherein step (a) is performed using a water-filling algorithm.

3. The method of claim 2, wherein the water-filling algorithm minimizes transmit power.

4. The method of claim 1, wherein step (e) is performed using a water-filling algorithm.

5. The method of claim 1, wherein step (c) comprises ordering the subcarriers according to the estimated transmission power of the subcarriers.

6. The method of claim 1, wherein step (c) comprises ordering the subcarriers according to decreasing total transmission power of the subcarriers.

7. The method of claim 1, wherein step (c) comprises ordering the subcarriers according to decreasing channel gain statistics.

8. The method of claim 1, wherein step (c) comprises ordering the subcarriers according to the decreasing number of bits.

9. The method of claim 1, further comprising using the assigned time slot in an orthogonal frequency division multiplex-time division duplex (OFDM-TDD) communication system.

10. The method of claim 1, further comprising using the assigned frequency in an orthogonal frequency division multiplex-frequency division duplex (OFDM-FDD) communication system.

11. The method of claim 1, wherein step (e) further comprises maintaining a list of banned subcarriers, and preventing subsequent assignment of users to the banned subcarriers.

12. A method of assigning subcarriers for transmission in a multiuser orthogonal frequency division multiplex (OFDM) carrier assignment, the method comprising:
determining the desired subcarriers for each user;
determining whether any conflicting subcarriers exist and, if there are no conflicting subcarriers, skipping to the accepting step;
ordering the subcarriers in an order of decreasing total transmit power of the subcarrier;
calculating the total transmit power increase for each selected user as if the conflicting subcarrier was assigned to the user and all other users using the conflicting subcarrier were reassigned to other subcarriers;
arbitrating the conflicting subcarrier to the assigned user which results in the least total transmit power increase;
reassigning other users to subcarriers using a water-filling algorithm and updating a list of conflicting subscribers and returning to the ordering step; and
accepting the determination of the desired subcarriers for each user.

13. The method of claim 12, wherein the step of determining the desired subcarriers for each user includes using a water-filling algorithm to determine the desired subcarriers.

14. The method of claim 12, further comprising using the assigned time slot in an orthogonal frequency division multiplex-time division duplex (OFDM-TDD) communication system.

15. The method of claim 12, further comprising using the assigned frequency in an orthogonal frequency division multiplex-frequency division duplex (OFDM-FDD) communication system.

16. A communication device capable of assigning subcarriers in a multiuser orthogonal frequency division multiplex (OFDM) carrier assignment, the radio communications device comprising:
a circuit for determining a list of desired subcarriers for each user;
a circuit for determining whether any conflicting subcarriers exist, and if no conflicting subcarriers exist, accepting the determination of the desired subcarriers for each user, whereas if conflicting subcarriers, ordering the subcarriers based upon a specific criteria;
a circuit for assigning subcarriers by selecting one user as assigned to a specific conflicting subcarrier and reassigning other users that have the specific conflicting subcarrier in their desired list, and repeating this step for each user and calculating the increase in said specific criteria;
a circuit for arbitrating the conflicting subcarrier to the user that results in the lowest increase in said specific criteria;
a database maintenance circuit which reassigns other users to subcarriers and updates a list of conflicting subcarriers.

17. The communications device of claim 16, wherein the circuit for the determination of the desired subcarriers for each user uses a water-filling algorithm to determine the desired subcarriers.

18. The communication device of claim 17, wherein the circuit for the determination of the desired subcarriers for each user uses the water-filling algorithm to provide a bit allocation solution to minimize transmit power.
